(19) United States
(12) Patent Application Publication
(10) Pub. No.: US 2005/0179314 A1
(43) Pub. Date: Aug. 18, 2005

(54) Trailer and semi-trailer braking system

(76) Inventors: Bence Csak, Budapest (HU); Harro Heilmann, Ostfildern (DE); Andreas Schwarzhaupt, Oberrot (DE); Gernot Spiegelberg, Heimsheim (DE); Armin Sulzmann, Oftersheim (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/920,448

(22) Filed: Aug. 18, 2004

(30) Foreign Application Priority Data
Aug. 22, 2003 (DE) 103 38 571.1

(51) Int. Cl. B60T 13/00

(52) U.S. Cl. 303/7

(57) ABSTRACT

A braking system (1) of a trailer or semi-trailer comprises wheel braking devices for each axle, which are supplied with compressed air by electronically controllable valves (14-16), a valve (14-16) and a compressed-air reservoir (17-19) in each case being assigned to each axle (2-4). The braking pressure is individually adjustable for each axle (2-4), in which case, because of the compressed-air reservoirs (17-19), a high braking pressure can be applied to the wheel braking devices.

### BACKGROUND AND SUMMARY OF THE INVENTION

The invention relates to a braking system of a trailer or semi-trailer, having axle bodies assigned to the wheels of the trailer, each axle body having pneumatically operated wheel braking devices.

Known trailer braking systems and trailer air suspensions are supplied with compressed air by the traction vehicle by way of a compressed-air supply line. The controlling takes place in a single-channel manner pneumatically by way of the trailer brake valve, which is arranged in the traction vehicle, and in a single-channel manner electronically by way of a brake CAN bus. However, between the traction vehicle and the trailer, only a maximal pressure of 8.5 bar can be transmitted to the trailer. This is the result of the fact that compressed-air hoses should only transmit a maximum pressure of 8.5 bar. The pressure maximally available at the trailer for the braking operation is therefore limited. Nowadays, it is desirable to have a higher brake pressure available for braking heavily loaded trailers.

It is therefore an object of the present invention to further develop a braking system of the above-mentioned type such that a high braking power can be made available at the trailer, while maintaining a simple construction of the system.

This object is achieved by providing a trailer or semi-trailer braking system, wherein a separate electrically controllable valve and a separate compressed-air reservoir are assigned to each axle body. The wheel braking devices of each axle body are capable of being acted upon by compressed air from the assigned compressed-air reservoir by way of the electrically controllable valve assigned to the axle body. Further and advantageous developments are described and claimed herein.

If a separate electronically controllable valve and a separate compressed-air reservoir are assigned to each axle body—in which case the wheel braking devices of each axle body can be acted upon by air pressure from the assigned compressed-air reservoir by way of the electrically controllable valve assigned to the axle body—the braking force can be adjusted individually for each axle. In addition, the mutually independent compressed-air reservoirs provide for sufficient braking pressure to be available to each axle, particularly more than 8.5 bar. As a result of the electronic controlling of the valves, the braking force available at the wheels can be controlled particularly rapidly and precisely. In addition, the coupling to the traction vehicle can be simplified. The storage line typically existing between the traction vehicle and the trailer can be eliminated because the pressure is stored in the compressed-air reservoirs in each case assigned to the axles. One advantage is the fact that only electric energy has to be transmitted from the traction vehicle, and the compressed air can be generated by a compressor in the trailer.

It is particularly preferable for each electrically controllable valve to be arranged in an axle modulator, and for at least two redundantly constructed data transmission branches to be connected to the axle modulators. Control information for the valves can therefore be transmitted to the axle modulators, and the electrically controllable valves arranged therein can be controlled. The axle modulators control the pressure in the wheel braking devices on both sides of the axle. Basically, it is contemplated to provide one axle modulator for each axle body or one axle modulator for each wheel. In both variants, it is contemplated to connect and control an axle modulator by way of a data transmission branch or by way of two redundantly constructed data transmission branches.

The data transmission branches may have a redundant construction so that the axle modulators are controlled in a reliable manner. Even in the event of the failure of one data transmission branch, a reliable braking of the trailer or semi-trailer will be ensured because the control signals will still be transmitted by the other data transmission branch. One data transmission branch can be connected to a central control unit, which may be arranged in the trailer or semi-trailer. Thus, it is sufficient to transmit data from the traction vehicle to the central control unit, which then transmits the corresponding control commands to the axle modulators of the individual axles. The central control unit can additionally be used for controlling the illumination, the loading management and the electrically controllable lifting support operation of the trailer. On the other hand, data can be transmitted from the central control unit to the traction vehicle, so that the driver of the traction vehicle will always be informed of the condition of the trailer or semi-trailer.

In a particularly space-saving manner, the compressed-air reservoirs can, in each case, be arranged in the axle body. When an axle is mounted or exchanged, the compressed-air reservoir is simultaneously mounted or exchanged. An additional connecting of the axle body or of the braking system with an external compressed-air reservoir can be eliminated. By providing a compressed-air reservoir for each axle, it is ensured that sufficient braking pressure is always available. Even if a compressed-air reservoir of one axle were to fail, the other axles could still brake.

An overflow valve with a limited return flow is advantageously provided on each axle body, by way of which overflow valve the compressed-air reservoir is connected with a common compressed-air supply, particularly a compressed-air supply line. The return-flow-limited overflow valve has the effect that, in the event of a pressure drop in the compressed-air supply line, the air pressure in the compressed-air reservoir is maintained. Thus, even in the event of a defect in the compressed-air supply, sufficient compressed air will be available for braking an axle.

Preferably, an electrically driven compressor is provided for generating the compressed air. Thus, the compressed air required for the braking can be generated in the trailer itself and independently of the traction vehicle. The trailer is therefore self-sufficient with respect to the traction vehicle. As a result of the compressor, a higher pressure (particularly 10 bar) can be generated than can be transmitted from the traction vehicle to the trailer in the case of conventional trailers. This increases the active safety of the trailer.

The operational reliability of the braking system can be increased in that an air dryer is provided. The air dryer dries the compressed air before it arrives in the compressed-air reservoirs.

If a common voltage is supply provided, then both the electric motor for operating the compressor and the axle modules can be supplied with voltage. Preferably, the voltage source is situated in the traction vehicle and the electric voltage is transmitted to the trailer by way of corresponding electrical lines.

If an electronic control system for controlling the brake and the air suspension is provided for each axle, then the failure of one electronic control system does not affect the remaining axles. In addition, different axles can be combined when a trailer is assembled. They do not all have to be connected with a joint electronic control system.

In an alternative embodiment, the axle modulators are controlled by way of a data transmission branch, particularly by way of one of the redundantly connected data transmission branches, as a function of the braking pressure which is applied to a brake valve arranged in the traction vehicle. In this manner, a trailer with the braking system according to the invention can also be hitched to a conventional traction vehicle. In the trailer brake valve, the pressure controlled by way of a control line into the trailer brake valve can be measured through the use of a pressure sensor. The pressure is analyzed and transmitted to the axle modulators, where the electrically controllable valves of the individual axles are controlled correspondingly.

Embodiments of the invention will be explained in detail by means of a drawing.

### BRIEF DESCRIPTION OF THE DRAWINGS

FIG. 1 is a schematic view of a first embodiment of a braking system; and

FIG. 2 is a schematic view of a second embodiment of a braking system.

### DETAILED DESCRIPTION OF THE DRAWINGS

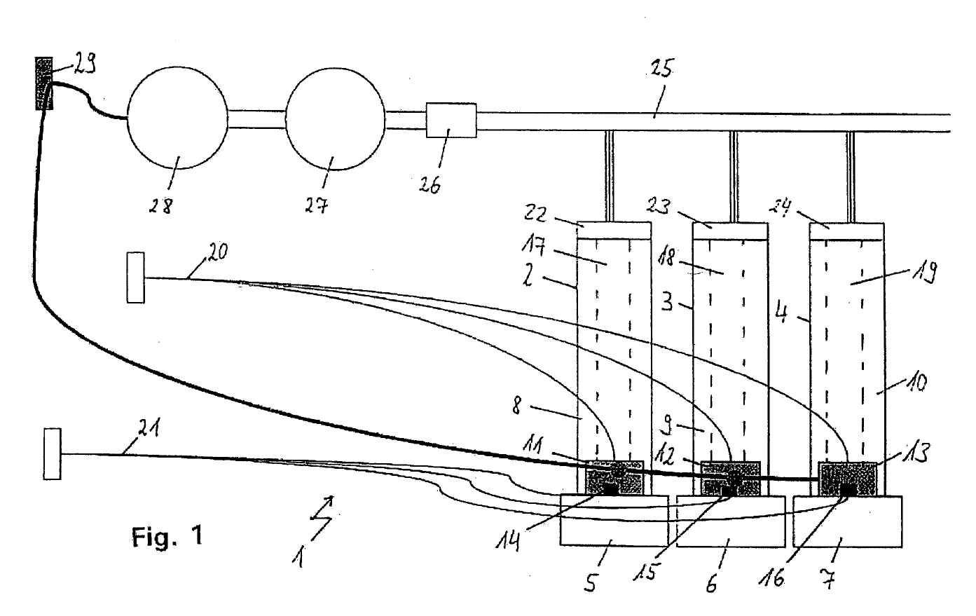

FIG. 1 schematically illustrates a first embodiment of a braking system 1 of a trailer or semi-trailer. The trailer has several axles 2-4 which have compressed-air-operated wheel braking devices for the braking of wheels 5-7. Each axle 2-4 has an axle body 8-10 to which one axle module 11-13 is respectively assigned. In each axle module 11-13, an electrically controllable valve 14-16 is arranged, which supplies the wheel braking devices with compressed air from, in each case, one compressed-air reservoir 17-19 integrated in the axle bodies 8-10 for braking the trailer.

In the embodiment, the controlling of the axle modules 11-13 and, thus, the operation of the electrically controllable valves 14 to 16 takes place by way of redundantly constructed data transmission branches 20, 21 from the traction vehicle. It is also contemplated to provide only one data transmission branch.

Compressed air for operating the wheel braking devices is stored in the compressed-air reservoirs 17-19. By means of overflow valves 22-24 with a limited return flow, the compressed-air reservoirs 17-19 are connected with a common compressed-air supply line 25. The overflow valves 22-24 have the effect that, in the event of a pressure drop in the pressure supply line 25, the air pressure in the respective compressed-air reservoir 17-29 is maintained. The compressed air present in the compressed-air supply line 25 is dried by an air dryer 26 and generated in a compressor 27. In the embodiment shown, the compressor 27 is arranged in the trailer. It is driven by an electric motor 28, which is fed by a common voltage supply 29 to which the axle modules 11-13 are also connected. The voltage supply 29 is arranged in the traction vehicle.

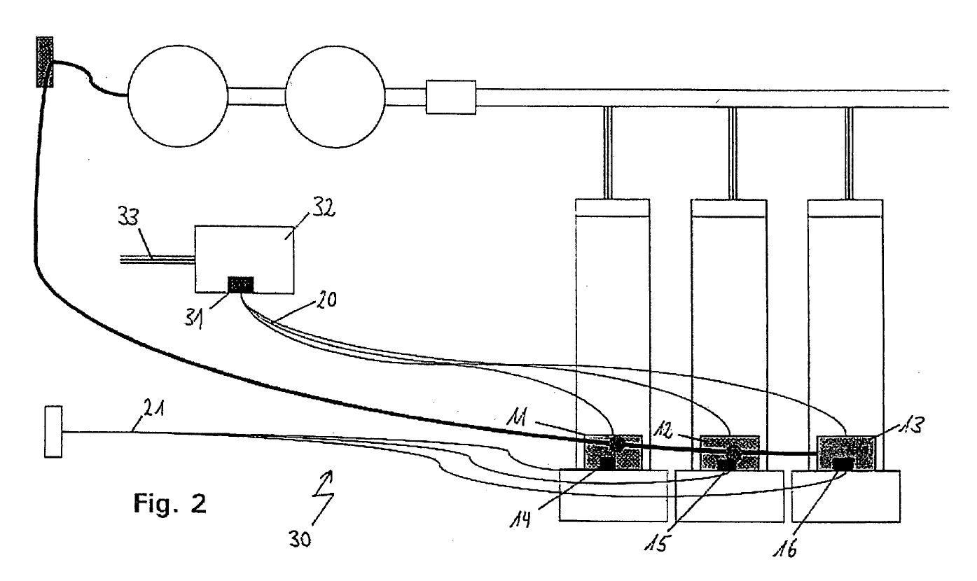

In the embodiment of a braking system 30 illustrated in FIG. 2, one of the redundantly constructed data lines 20, 21 is connected with a pressure sensor 31. By way of a data line, the pressure sensor 31 can be connected with a central electronic system. This pressure sensor 31 detects the braking pressure present at the trailer brake valve 32 of the traction vehicle. This braking pressure is processed for controlling the axle modules 11-13 or the electrically controllable valves 14-16. As a result, the axle modules 11-13 are controlled as a function of the braking pressure present at the trailer brake valve 32. A control line 33 of the traction vehicle is led to the trailer brake valve 32.

For each axle, a braking system 1 of a trailer or semi-trailer includes wheel braking devices, which are supplied with compressed air by electronically controllable valves 14-16. One valve 14-16 and one compressed-air reservoir 17-19 are, in each case, assigned to each axle 2-4. The braking pressure is individually adjustable for each axle 2-4, in which case a high braking pressure can be applied to the wheel braking devices as a result of the compressed-air reservoirs 17-19.

1. A braking system of a trailer or semi-trailer eguipped with axle bodies assigned to wheels, each axle body having pneumatically operated wheel braking devices, comprising:
a separate electrically controllable valve and a separate compressed-air reservoir assigned to each axle body,
wherein the wheel braking devices of each axle body are acted upon by compressed air from the separate compressed-air reservoir by way of the separate electrically controllable valve assigned to each axle body.

2. The braking system according to claim 1, wherein each electrically controllable valve is arranged in a respective axle modulator, and at least two redundantly constructed data transmission branches are connected to the axle modulators.

3. The braking system according to claim 1, wherein the compressed-air reservoirs are each arranged in the axle body.

4. The braking system according to claim 1, further comprising:
an overflow valve with a limited return flow provided at each axle body, by way of which overflow valve the compressed-air reservoir is connected with one of a common compressed-air supply and a compressed-air supply line.

5. The braking system according to claim 1, wherein an electrically driven compressor is provided for generating compressed air.

6. The braking system according to claim 1, further comprising an air dryer for operating on the air supply.

7. The braking system according to claim 1, further comprising a common voltage supply for powering the braking system.

8. The braking system according to claim 1, wherein an electronic control system for controlling the brake system and an air suspension is provided for each axle.

9. The braking system according to claim 1, wherein the axle modulators are controlled by way of a data transmission branch as a function of the braking pressure which is present at a trailer brake valve arranged in a traction vehicle.

10. The braking system according to claim 3, further comprising:
an overflow valve with a limited return flow provided at each axle body, by way of which overflow valve the compressed-air reservoir is connected with one of a common compressed-air supply and a compressed-air supply line.

11. The braking system according to claim 3, wherein an electrically driven compressor is provided for generating compressed air.

12. The braking system according to claim 10, wherein an electrically driven compressor is provided for generating compressed air.

13. The braking system according to claim 1, wherein the axle modulators are controlled by way of one of the redundantly constructed data transmission branches as a function of a braking pressure present at a trailer brake valve arranged in a traction vehicle.

14. A trailer braking system having at least one axle body assigned to wheels of the trailer, said axle body being equipped with pneumatically operable wheel brakes, the trailer braking system comprising:
an electrically controllable valve;
a separate compressed-air reservoir;
wherein the electrically controllable valve and the compressed-air reservoir are assigned to the one axle body; and
wherein the wheel brakes of the one axle body are acted upon by compressed air from the assigned compressed-air reservoir by way of the electrically controllable valve.

15. The trailer braking system according to claim 14, wherein the trailer braking system includes a plurality of axle bodies, each of which has assigned a separate electrically controllable valve and a separate compressed-air reservoir.

16. The trailer braking system according to claim 15, wherein each of the plurality of axle bodies has a separate axle modulator, in which is arranged the assigned electrically controllable valve; and
wherein at least two redundantly constructed data transmission branches are coupled to the axle modulators.

17. The trailer braking system according to claim 15, wherein the separate compressed-air reservoir for each axle body is arranged within the axle body.

18. The trailer braking system according to claim 17, further comprising:
one of a common compressed-air supply and a common compressed-air supply line;
each of the plurality of axle bodies having a separate overflow valve with a limited return flow, wherein the overflow valve couples the compressed-air reservoir with said one of the common compressed-air supply and common compressed air-supply line.

19. The trailer braking system according to claim 16, wherein the axle modulators are controlled by way of one of the at least two redundantly constructed data transmission branches as a function of a braking pressure present at a trailer brake valve arranged in a traction vehicle.
